(19) United States
(12) Patent Application Publication
(10) Pub. No.: US 2002/0144222 A1
(43) Pub. Date: Oct. 3, 2002

(54) Method of simulating PLL circuit and computer program product therefor

(75) Inventor: Hajime Noseyama, Kanagawa (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/108,629

(22) Filed: Mar. 29, 2002

(30) Foreign Application Priority Data
Mar. 30, 2001 (JP) 2001-102588

(51) Int. Cl. G06F 17/50

(52) U.S. Cl. 716/4

(57) ABSTRACT

A method of simulating a PLL circuit is provided, which makes it possible to accurately judge the frequency of the feedback clock signal to conduct simulation even if the frequency of the output clock signal is changed according to the necessity. The PLL circuit has a reference input terminal into which a reference clock signal with a reference clock frequency is inputted, a feedback input terminal into which a feedback clock signal is inputted, and output terminals from which output clock signals are outputted. The output clock signals include at least one of a multiplied output clock signal and a divided output clock signal. In the step (a), different dummy signals are outputted to the output terminals, respectively. In the step (b), a signal fed back to the feedback input terminal is detected to find which one of the dummy signals the signal thus fed back corresponds to, thereby recognizing which one of the output terminals is connected to the feedback input terminal.

### BACKGROUND OF THE INVENTION

1. Field of the Invention

The present invention relates to simulation of a Phase-Locked Loop (PLL) circuit. More particularly, the invention relates to a method of simulating a PLL circuit having output terminals for outputting clock signals with different frequencies, and a computer program product for conducting the method. The invention is preferably applicable to the logic simulation of a large-scale logic circuit including a PLL circuit or circuits.

2. Description of the Related Art

In recent years, the “Event Driven method” has been generally used to conduct the logic simulation. With the “Event Driven method”, the change of a signal in a logic circuit is termed an “event”, and the operation of a logic circuit is simulated based on each event.

Specifically, when an event occurs at a designated time (which is termed the “current time” below), specific circuit cells (e.g., AND, OR, and flip-flops) whose input signals are changed by the event are identified out of the circuit cells constituting a logic circuit to be simulated. Then, only the cells thus identified (i.e., the target cells) are subjected to calculation of operation. This calculation is carried out using a proper “simulation model” that includes the definition of operation of the circuit cells. A “simulation model” may be refereed simply as a “model” below. If the output signals of the target cells are changed by the result of the calculation, the change of the output signals are treated as new events. The occurring time of each new event is set at a time when a predetermined time delay is added to the current time. Each new event is then registered at the occurring time thus set. These procedures are repeated while the current time is successively advanced, thereby simulating the operation of the whole logic circuit.

In general, a large-sized logic circuit includes a PLL circuit to suppress the clock skew. Conventionally, as the method of conducting the logic simulation of a logic circuit including a PLL circuit with the event driven method, there is a logic simulation method using a “dummy model” for the calculation for the PLL circuit operation. The “dummy model” is a model that copes with a circuit cell (i.e., a delay circuit) whose output signal is produced by delaying the phase of its input signal by a predetermined time delay. However, the characteristic behavior of the PLL circuit is unable to be simulated with the conventional method using the “dummy model”. The reason is as follows:

Originally, with a PLL circuit, the phase of the output clock signal of the PLL circuit is controlled in such a way that the reference clock signal inputted and the feedback clock signal fed back are always synchronized with each other. In other words, if some phase difference occurs between the reference clock signal and the feedback clock signal, the phase of the output clock signal is adjusted according to the phase difference. For example, if the phase of the feedback clock signal or the frequency of the reference clock signal changes, the phase of the output clocksignal is changed to keep the synchronization between the reference clock signal and the feedback clock signal. This operation that the phase of the output clock signal is changed corresponding to the phase of the feedback clock signal is a characteristic behavior of the PLL circuit.

Unlike this, with the conventional simulation method using the “dummy model”, the simulation of the PLL circuit is carried out using the standard delay value stored in the Standard Delay File (SDF) and therefore, the phase of the output clock signal is determined independent of the phase of the feedback clock signal. This means that the reference clock signal is not synchronized with the feedback clock signal. Accordingly, the simulation is done to the operation (i.e., the non-synchronized operation) where the refference, clock siqnal is not synchronize1d with the feedback clock signal. This results in degradation of simulation accuracy.

Another conventional logic simulation method is a method using the “netlist-type model” that reproduces precisely the operation of the PLL circuit.

With the method using the “netlist-type model”, the above-described intrinsic operation of the PLL circuit is simulated and therefore, the operation (i.e., the synchronized operation) where the reference clock signal and the feedback clock signal are synchronized with each other can be simulated. However, several thousands of the clock count is necessary to reach the synchronized operation form the non-synchronized operation. This results in enormous simulation time. Because of this reason, this method is not usually adopted.

To solve the above-described problems or disadvantages, various improved simulation methods have ever been developed and disclosed.

For example, the Japanese Non-Examined Patent Publication No. 9-5397 published in 1997 discloses a logic simulation method that solves the above-identified problems. With this method, a “delay means” is provided to give a specific delay time to the output clock signal (i.e., the internal clock signal) of a PLL circuit. A delay time between the output clock signal of the PLL circuit and the feedback clock signal thereof is added to the predetermined delay time by the delay means. Thus, a “virtual clock signal”, which has a phase advanced from that of the reference clock signal by the delay time thus added, is generated. Then, the logic simulation is carried out using the “virtual clock signal” thus generated.

The Japanese Non-Examined Patent Publication No. 9-5396 discloses another logic stimulation method that solves the above-identified problems. With this method, a “delayed output clock signal” (i.e., the internal clock signal) is generated. The “delayed output clock signal” is delayed by a time generated by subtracting a specific delay time from the time corresponding to one period of the reference clock signal (i.e., the external clock signal).

With the two prior-art logic simulation methods disclosed by the Publication No. 9-5397, as described above, the characteristic synchronized operation of a PLL circuit can be simulated with the use of the “virtual clock signal” or the “delayed output clock signal”.

The Japanese Non-Examined Patent Publication No. 2000-278118 published in 2000 also discloses a logic simulation method that solves the above-identified problems. With this method, the time difference (i. e., the phase difference) from a time (i e., the reference time) at which the “feedback clock signal” changes to the current time at which the “reference clock signal” starts to rise or fall is calculated. The time difference thus calculated is defined as the “additional delay value”. Therafter, for example, if the reference clock signal starts to fall, a first delay value is defined as the delay time. If the reference clock signal starts to rise, a second delay value (=the first time delay+the additional delay value) is defined as the delay time. Thus, the change of the output clock signal that occurs after the current time is delayed by the first or second delay value according to the change of the reference clock signal.

Since the “additional delay value” is a time difference (i.e., a phase difference) from the reference time to the current time, the phase difference between the reference clock signal and the feedback clock signal is eliminated at the time delayed by the additional delay value, in other words, the reference clock signal and the feedback clock signal are synchronized with each other. As a result, both the synchronized and non-synchronized operations of a PLL circuit can be simulated. Moreover, the time for calculation or simulation can be shortened, because a lot of the clock count is not necessary for the simulation method to calculate the additional delay value.

Recently, a type of PLL circuits that produce a “multiplied output clock signal” and a “divided output clock signal” have been developed and practically used. The “multiplied output clock signal” is a clock signal with a frequency that corresponds to the multiplication result of the frequency of the reference clock signal (i.e., the reference clock frequency) and a positive constant m greater than unity. The “divided output clock signal” is a clock signal with a frequency that corresponds to the division result of the reference clock frequency and a positive constant n greater than unity, The multiplied and divided output clock signals are outputted from the multiplication and division output terminals provided in the PLL circuit, respectively. The conventional output clock signal (which may be termed the multiplied output clock signal by unity) with the same frequency as the reference clock frequency is outputted from the standard or reference output terminal.

Some of the type of PLL circuits that produce the “multiplied output clock signal” and/or the “divided output clock signal” have a “lock output terminal”. The lock output terminal is used to output a “lock signal” for controlling the operation of other circuits connected in a subsequent stage or stages (i.e., the subsequent circuits). If a specific output clock signal is synchronized with the reference clock signal, the lock signal is in the lock state (i.e., LOCK−1) and as a result, the subsequent circuits are kept operable. If the synchronization of the output clock signal with the reference clock signal is broken due to some reason, the lock signal is turned to the unlock state (i.e., LOCK =0) and as a result, the subsequent circuits are turned to be inoperable.

The logic simulation methods disclosed by the Japanese Non-Examined Patent Fublication No. 9-5397 have the following three problems.

The first problem is that the lock signal is unable to be controlled, because the logic state of the lock signal outputted from the lock output terminal of the PLL circuit is not explained or referred.

The second problem is that the frequency of the reference clock signal (and therefore, the output clock signal) needs to be determined in advance in the PLL model, because the “virtual clock signal” or the “delayed output clock signal” is generated by the delay means. In other words, the methods of the Publication No. 9-5397 are unable to be applied to the case where the frequency of the output clock signal is changed (i.er multiplied or divided) according to the necessity.

The third problem is that the clock count required for reaching the synchronization in phase of the output clock signal with the reference clock signal is unable to be adjusted, because it is not referred or explained.

The logic simulation method disclosed by the Japanese Non-Examined Patent Publication No. 2000-278118 has the following problems.

Specifically, with this methods the phase comparison between the reference clock signal and the feedback clock signal is carried out by using the rising or falling edge thereof. Thus, the clock frequency of the output clock signal must be constant. This means that this method is unable to be applied to the case where the frequency of the output clock signal is changed (i.e, multiplied or divided) according to the necessity. This is the first problem of the method of Publication No. 2000-278118.

If this method is applied to this case, which clock frequency the feedback clock signal has must be judged in the PLL model. To realize this, however, the interconnection information of the constituent circuits needs to be prepared in the PLL model. In this case, the PLL model itself must be changed if some change of the circuit configuration occurs, which makes the simulation activity extremely complicated.

Moreover, with the method disclosed by the Publication No. 2000-278118, the lock signal, which is outputted from the lock terminal, is unable to be controlled. This is the second problem of this method.

### SUMMARY OF THE INVENTION

Accordingly, an object of the present invention is to provide a method of simulating a PLL circuit that makes it possible to accurately judge the frequency of the feedback clock signal to conduct simulation even if the frequency of the output clock signal is changed (i.e., multiplied or divided) according to the necessity, and a computer program product used therefor.

Another object of the present invention is to provide a method of simulating a PLL circuit that controls accurately the logic of the lock signal outputted from the lock terminal, and a computer program product used therefor.

Still another object of the present invention is to provide a method of simulating a PLL circuit that is capable of adjusting the clock count necessary for reaching the synchronization of the output clock signal with the reference clock signal, and a computer program product used therefor.

The above objects together with others not specifically mentioned will become clear to those skilled in the art from the following description.

According to the first aspect of the invention, a method of simulating a PLL circuit is provided. This method is applied to a PLL circuit having a reference input terminal into which a reference clock signal with a reference clock frequency is inputted, a feedback input terminal into which a feedback clock signal is inputted, and output terminals from which output clock signals are respectively outputted. The output clock signals include at least one of a multiplied output clock signal and a divided output clock signal. The multiplied output clock signal has a frequency that corresponds to multiplication result of the reference clock frequency with a positive constant m greater than unity. The divided output clock signal has a frequency that corresponds to division result of the reference clock frequency by a positive constant n greater than unity.

The method according to the first aspect of the invention comprises the following steps (a) and (b).

In the step (a), different dummy signals are outputted to the output terminals, respectively.

In the step (b), a signal fed back to the feedback input terminal is detected to find which one of the dummy signals the signal thus fed back corresponds to, thereby recognizing which one of the output terminals is connected to the feedback input terminal.

With the method of simulating a PLL circuit according to the first aspect of the invention, the different dummy signals are respectively outputted to the output terminals of the PLL circuit in the step (a). Thereafter, in the step (b), the signal fed back to the feedback input terminal of the PLL circuit is checked to find which one of the dummy signals the signal thus fed back corresponds to, thereby recognizing which one of the output clock terminals is connected to the feedback input terminal.

Accordingly, even if the frequency of the output clock signal is changed (i.e., multiplied or divided) according to the necessity, the frequency of the feedback clock signal can be judged accurately to conduct the simulation of the PLL circuit. Moreover, no change is required for the simulation model used.

When the PLL circuit comprises a lock terminal from which a lock signal for controlling operation of a subsequent circuit is outputted, the operation of the PLL circuit is controlled accurately. This is because which one of the output clock terminals is connected to the feedback input terminal is recognized in the step (b). As a result, the logic of the lock signal outputted from the lock terminal can be controlled accurately.

Furthermore, by adjusting the clock count required until the PLL circuit starts its synchronization operation, the clock count necessary to reach the synchronization of the output clock signal with the reference clock signal can be adjusted.

In a preferred embodiment of the method according to the invention, each of the dumay signals is a pulsed signal having a different logic value. In this embodiment, it is preferred that the pulsed signal includes at least two of “0”, “1”, and “X”.

In another preferred embodiment of the method according to the invention, each of the dummy signals is a pulsed signal having a different period or frequency. In this embodiment, it is preferred that the pulsed signal has a different repetition rate of pulses.

In still another preferred embodiment of the method according to the invention, each of the dummy signals is a pulsed signal having a different combination of logic values. In this embodiment, it is preferred that the pulsed signal has a different combination of logic values of bits.

In a further preferred embodimeint of the method according to the invention, after the step (b), the following steps (c) to (g) are carried out.

In the step (c), a first time at which the reference clock signal occurs and a second time at which the feedback clock signal occurs are stored.

In the step (d) a period of the reference clock signal is compared with a period of the feedback clock signal.

In the step (e), according to result of comparison in the step (d), occurrence of an event is detected with respect to one of the reference clock signal and the feedback clock signal.

In the step (f), whether or not the first time and the second time stored in the step (c) are equal to each other is judged.

In the step (g), a logic value of a specific lock signal is controlled according to result of judgment in the step (f), thereby making a specific subsequent circuit to the PLL circuit operable or inoperable.

According to the second aspect of the invention, a computer program product for simulating a PLL circuit is provided. This product is to conduct the method according to the first aspect of the invention. This program product has a computer readable medium and a computer program recorded thereon, which comprises:

(a) code that output respectively different dummy signals to the output terminals; and

(b) code that detects a signal fed back to the feedback input terminal to find which one of the dummy signals the signal thus fed back corresponds to, thereby discriminating which one of the output terminals is connected to the feedback input terminal.

With the computer program product according to the second aspect of the invention, obviously, there are the same advantages as those of the method of simulating a PLL circuit according to the first aspect of the invention.

### BRIEF DESCRIPTION OF THE DRAWINGS

In order that the present invention may be readily carried into effect, it will now be described with reference to the accompanying drawings.

FIG. 1 is a flowchart showing the steps of a method of stimulating a PLL circuit according to a first embodiment of the invention.

FIG. 2 is a flowchart showing the detail of the step of feedback terminal recognition in the method of simulating a PLL circuit according to the first embodiment of FIG. 1.

FIG. 3 is a flowchart showing the detail of the step of phase comparison in the method of simulating a PLL circuit according to the first embodiment of FIG. 1.

FIG. 4 is a circuit diagram showing the configuration of a PLL circuit to be simulated.

FIG. 5 is a timing diagram shoving the time-dependent change of the respective signals in the method of simulating a PLL circuit according to the first embodiment of FIG. 1.

FIG. 6 is a flowchart showing the detail of the step of feedback terminal recognition in a method of simulating a PLL circuit according to a second embodiment of the invention.

FIG. 7 is a timing diagram showing the time-dependent change of the respective signals in the method of simnulating a PLL circuit according to the second embodiment of the invention.

FIG. 8 is a flowchart showing the detail of the step of feedback terminal recognition in a method of simulating a PLL circuit according to a third embodiment of the invention.

FIG. 9 is a timing diagram showing the time-dependent change of the respective signals in the method of simulating a PLL circuit according to the third embodiment of the invention.

FIG. 10 is a flowchart showing the operation of a PLL circuit, in which the method of simulating a PLL circuit according to the first embodiment of FIG. 1 is applied to the prior-art method of simulating a PLL circuit.

FIG. 11 is a timing diagram showing the time-dependent change of the respective signals in the case of FIG. 10.

### DETAILED DESCRIPTION O)F THE PREFERRED EMBODIMENTS

Preferred embodiments of the present invention will be described in detail below while referring to the drawings attached.

### First Embodiment

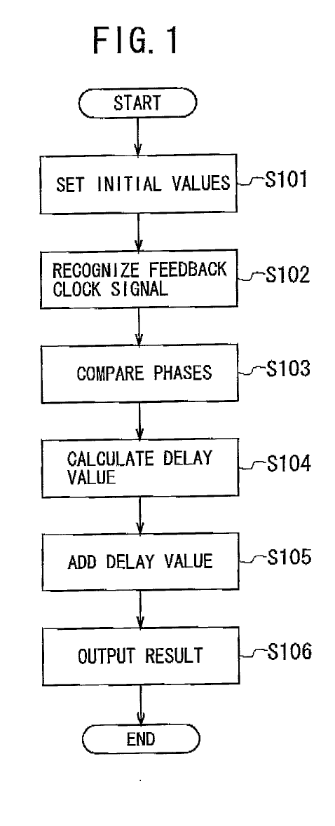

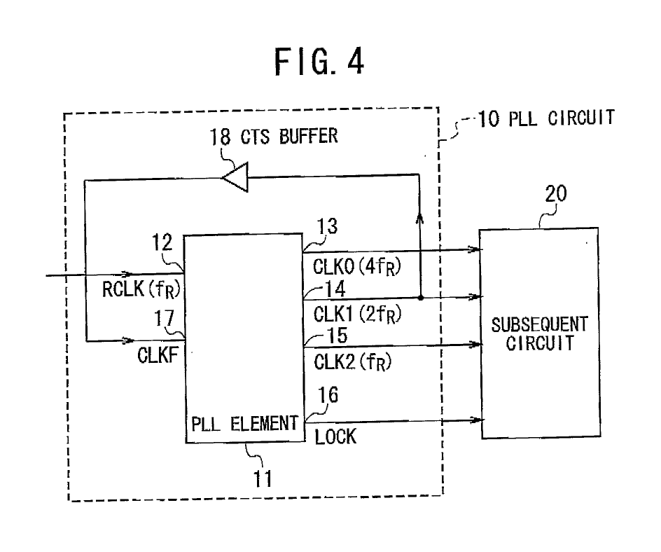

A method of simulating a PLL circuit according to a first embodiment of the invention is explained below with reference to FIGS. 1 to 4. FIGS. 1 to 3 show the flowcharts of the simulation method of the first embodiment while FIG. 4 shows the configuration of a PLL circuit to which the simulation method is applied.

As shown in FIG. 4, a PLL circuit 10 comprises a PLL element 11 and a CTS buffer circuit 18. The PLL element 11 has a reference input terminal 12, a fourfold multiplication output terminal 13, a twofold multiplication output terminal 14, a unity-fold multiplication output terminal 15, a lock terminal 16, and a feedback input terminal 17.

The reference input terminal 12 is used to receive a reference clock signal RCLK with a reference clock frequency of f_{R}. The fourfold multiplication output terminal 13 is used to output a fourfold multiplication clock signal CLK0 with a fourfold frequency of 4f_{R}. The twofold multiplication output terminal 14 is used to output a twofold maultiplication clock signal CLK1 with a twofold frequency of 2f_{R}. The uniity-fold multiplication output terminal 15 is used to output a unity-fold multiplication clock signal CLK2 with the same frequency as f_{R}. The lock terminal 16 is used to output a lock signal LOCK. The feedback input terminal 17 is used to receive a feedback clock signal CLKF.

The three output terminals 13, 14, and 15 and the lock terminal 16 are connected to a subsequent circuit 20 to be controlled by the PLL circuit 10. Thus, the fourfold multiplication output clock signal CLK0, the twofold multiplication output clock signal CLK1, the unity-fold multiplication output clock signal CLK2, and the lock signal LOCK are supplied to the circuit 20.

The reference clock signal RCLK and the feedback clock signal CLEF are inputted into the reference input terminal 12 and the feedback input terminal 17, respectively. In the circuit configuration of FIG. 4, the twofold multiplication output terminal 14 is connected to the feedback input terminal 17 by way of the CTS buffer circuit 18 and therefore, the twofold multiplication output clock signal CLK1 is inputted into the terminal 17.

In the PLL circuit 10, the PLL element 11 operates in such a way as to adjust constantly the phases of the three clock signals CLK0, CLK1, and CLK2 to thereby match the phase of the feedback clock signal CLKF with the phase of the reference clock signal RCLK. As a result, the feedback clock signal CLKF (i.e., the twofold multiplication output clock signal CLK1) is synchronized with the reference clock signal RCLK The output clock signals CLK0, CLK1, and CLK2, which are synchronized with the reference clock signal RCLK, are stably supplied to the subsequent circuit 20 in this way.

Next, the method of simulating a PLL circuit according to the first embodiment is explained below with reference to FIGS. 1 to 3.

In the step S101 of FIG. 1, specific input signals are initially applied to the respective input terminals of the simulation model for the PLL circuit 10 shown in FIG. 4. Thus, the logic states of these input terminals are set at their initial ones. In other words, the initial values of the PLL model are set or fixed. Thereafter, the simulation of the operation using the FLL model is started.

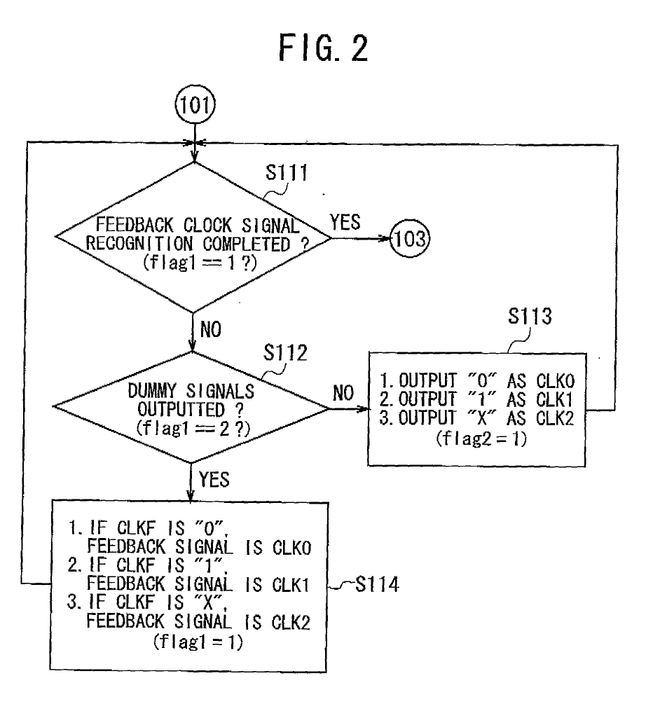

In the step S102 of FIG. 1, it is judged which one of the fourfold multiplication output clock signal CLK0, the twofold multiplication output clock signal CLK1, and the unity-fold multiplication output clock signal CLK2 is fed back to the feedback terminal 17 as the feedback clock signal CLKF. The detail of the step S102 is shown in FIG. 2. The following steps are carried out in the step S102, as shown in FIG. 2.

When the step S101 of setting the initial values is completed, the step S111 is then carried out. In the step S111, it is judged whether or not the step S102 of recognizing the feedback clock signal CLKF has been completed. The judgment of the step S111 is carried out by checking whether or not the variable “flag 1” has a value of “1”. If the “flag 1” has a value of “1”, the step S102 of recognizing the feedback clock signal CLKF has been completed and therefore, the step S103 is carried out without conducting the steps S112, S113, and S114. If the “flag 1” has a value of “0”, the step S102 has not completed yet and therefore, the next step S112 is carried out.

In the step S112, it is judged whether or not dummy signals have been outputted to the output terminals 13, 14, and 15, respectively. The judgment of the step S112 is carried out by checking whether or not the variable “flag 2” has a value of “1”. If the “flag 2” has a value of “1”, the output operation of the dummy signals has been completed and therefore, the step S114 is then carried out. If the “flag 2” has a value of “0”, the output operation of the dummy signals has not been completed yet and therefore, the next step S113 is carried out.

In the step S113, the dummy signals having the logic 0, 1, and X (“X” means “undefined” or “don't care”) are outputted to the output terminals 13, 14, and 15, respectively. In other words, the output clock signals CLK0, CLK1, and CLK2 are replaced with the dummy signals having the logic 0, 1, and X, respectively. Thereafter, the flow is returned to the step S111. Then, the step S111 is carried out again and then, the step S112 is carried out again. In this case, since the dummy signals have been outputted (in other words, the judgment result of the step S112 is “YES”), the step S114 is then carried out.

In the step S114, the feedback clock signal CLKF is recognized in the following way.

Specifically, the logic value of the dummy signal, which has been fed bacK to the feedback input terminal 13, is checked If the dummy signal thus fed back has a logic value of “0”, it is judged that the fourfold feedback clock signal CLK0 outputted from the terminal 13 is the feedback clock signal CLKF. Similarly, if the dummy signal thus fed back has a logic value of “1”, it is judged that the twofold feedback clock signal CLK1 outputted from the terminal 14 is the feedback clock signal CLKF. If the dummy signal thus fed back has a logic value of “X”, it is judged that the unity-fold feedback clock signal CLK2 outputted from the terminal is the feedback clock signal CLKF.

Thereafter, the flow is returned to the step S111. In this case, since the feedback signal has beenrecognized (in other words, the judgment result of the step S111 is “YES”), the step S103 is then carried out.

Additionally, the logic value of the lock signal LOCK outputted from the lock terminal 16 is compulsorily kept at “0” until the recognition of the feedback signal in the step S102 is completed.

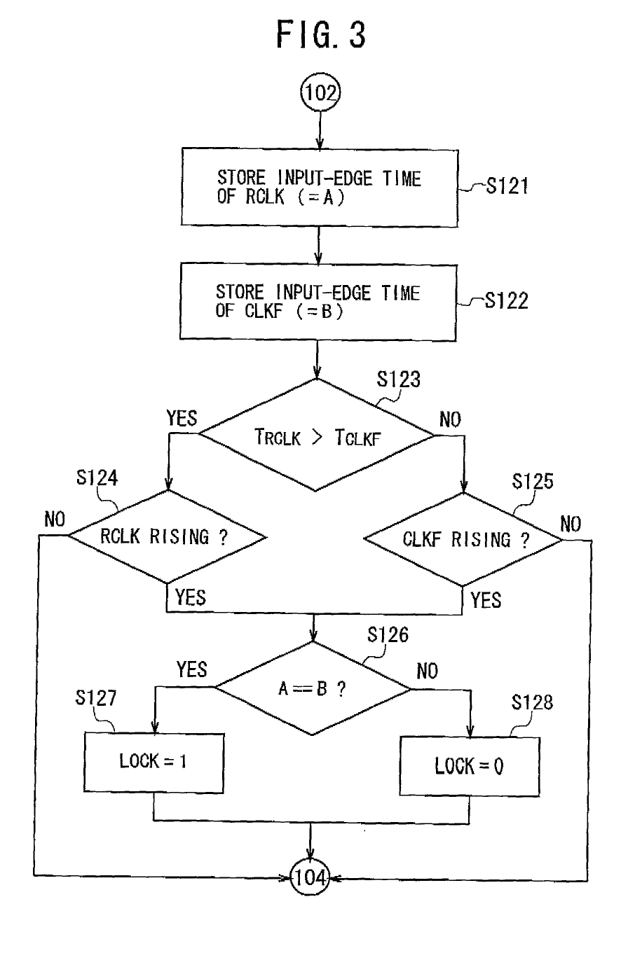

In the step S103 of FIG. 1, to set the value of the lock signal LOCK, the phase of the feedback clock signal CLKF is compared with the phase of the reference clock signal RCLK. The details of the step S103 is shown in FIG. 3.

In FIG. 3, in the step S121, which is carried out after the step S102 (i.e., the feedback signal recognition step) of FIG. 1 is completed, the time at which the input edge (i.e., the rising edge) of the reference clock signal RCLK occurs is recognized. This time is stored in the “variable A”.

In the next step S122, the time at which the input edge (i.e., the rising edge) of the feedback clock signal CLKF occurs is recognized. This time is stored in the “variable B”.

In the next step S123, it is judged whether or not the period T_{RCLK} of the reference clock signal RCLK is greater than the period T_{CLKF} of the feedback clock signal CLKF. If the period T_{RCLK} of the signal RCLK is greater than the period T_{CLKF} of the signal CLKF (i.e., T_{RCLK}>T_{CLKF}), the step S124 is then carried out. If the event of rising of the reference clock signal RCLK is detected in the step S124, the step S126 is carried out next. If the event of rising of the reference clock signal RCLK is not detected in the step S124, the step S104 of calculating the delay value is carried out next.

On the other hand, if the period T_{RCLK} of the signal RCLK is not greater than the period T_{CLKF} of the signal CLKF (i.e., T_{RCLK}≦T_{CLKF}) in the step S123, the step S125 is then carried out. If the event of rising of the feedback clock signal CLKF is detected in the step S125, the step S126 is carried out next. If the event of rising of the signal CLKF is not detected in the step S125, the step S104 of calculating the delay value is carried out next.

In the step S126, it is judged whether or not the stored values of the variables A and B are equal to each other, in other words, it is judged whether or not the feedback clock signal CLKF changes at the same time as the reference clock signal RCLK. This is to check the synchronization between the signals CLKF and RCLK. If the feedback clock signal CLKF changes at the same time as the reference clock signal RCLK, the step S127 is then carried out, in which the logic value of the lock signal LOCK is set at “1”. This means that the signals CLKF and RCLK are synchronized with each other. Subsequently, the step S104 is carried out.

On the other hand, if the feedback clock signal CLKF does not change at the same time as the reference clock signal RCLK in the step S126, the step S128 is then carried out, in which the logic value of the lock signal LOCK is set at “0”. This means that the signals CLKF and RCLK are not synchronized with each other. Subsequently, the step S104 is carried out.

As explained above, in the step S103 of FIG. 1 for phase comparison, the phases of the feedback clock signal CLKF and the reference clock signal RCLK are compared and then, the logic value of the lock signal LOCK is set at “1” if the phases of the signals CLKF and RCLK are the same. As a result, the subsequent circuit 20 is set to be operable. If the phases of the signals CLKF and RCLK are not the same, the logic value of the signal LOCK is kept at “0”. As a result, the subsequent circuit 20 is kept inoperable.

In the step S104 of FIG. 1, the phase difference (i.e., the delay value) between the signal CLKF and the signal RCLK is calculated and at the samae time, the frequency of the signal RCLK is measured. The phase difference or the delay value is “0” if the phases of the signals CLKF and RCLK are the same in the step S103.

In the step S105 of FIG. 1, a delay value is assigned to the feedback clock signal CLKF according to the phase difference calculated in the step S104, thereby delaying the signal CLKF by the delay value thus assigned. Thus, the phase of the signal CLKF is matched with the phase of the reference clock signal RCLK. If the phases of the signals CLKF and RCLK are not the same in the step S103, they are matched with each other at this stage.

In the step S106 of FIG. 1, the number of clocks of the reference clock signal ROLE is counted or measured and then, the schedule is made as follows. Specifically, the lock signal LOCK is scheduled to be outputted from the lock terminal 16 (from which the result of phase comparison is outputted) with a specific locking timing according to the result of measurement.

Next, the above-described method of simulating a PLL circuit according to the first embodiment is explained in more detail below using a concrete example.

Here, it is supposed that the following conditions are set in the example.

Reference Clock Signal RCLK: f_{R}=20 MHz

Fourfold Output Clock Signal CLKO: f_{R}×4=80 MHz

Twofold Output Clock Signal CLK1: f_{R}×2=40 MHz

Fourfold Output Clock Signal CLK2: f_{R}×1=20 MHz

Lock signal LOCK: “1” if the phases of RCLK and CLKF are the same, while “0” if the phases of RCLK and CLKF are not the same. If the rising edge of RCLK appears six times (i.e., the period of RCLK passes six times) after the phases RCLK and CLKF are matched, the lock signal LOCK is outputted to the subsequent circuit 20.

The reference clock frequency f_{R} of the signal RCLK is optionally determined by the user, which is recognized by measuring the frequency f_{R} in the PLL model. The other conditions than f_{R} are determined by the specification of the PLL model itself.

In actual circuit design, the user determines optionally which one of the clock signals CLK0, CLK1, and CLK2 is used as the feedback clock signal CLKF based on the circuit specification given. Here, the twofold output clock signal CLK1 is used as the feedback clock signal CLKF.

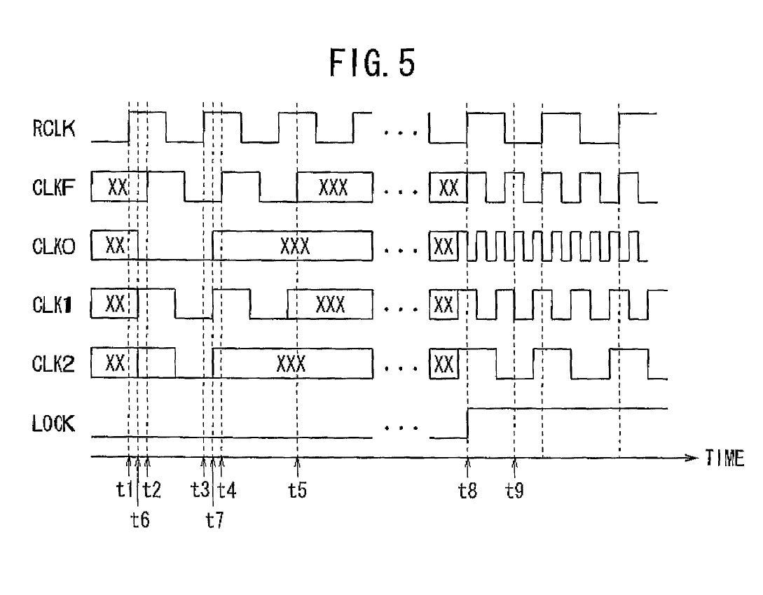

FIG. 5 shows the timing diagram showing the time-dependent change of the respective signals in the method of simulating a PLL circuit according to the first embodiment.

First, at the time t1, the reference clock signal RCLK rises, from which the processing (i.e., the step S101 and the subsequent steps) of the PLL model begins. The logic states of the respective signals at the time t1 correspond to the initial values given in the step S101.

In the step S102 of feedback signal recognition, the different dummy signals are respectively outputted to the output terminals 13, 14, and 15 of the PLL element 11 within a limited period, and then, the signal fed back to the feedback terminal 17 is monitored. According to the type of the dummy signal fed back to the terminal 17, which one of the output terminals 13, 14, and 15 is connected to the feedback terminal 17 is recognized.

Specifically, in the step S111 of FIG. 2, whether or not the recognition operation of the feedback clock signal CLKF has been completed is judged using the variable “flag 1” provided in the PLL model. If the “flag 1” has a value of “0”, it is found that the recognition has not been completed yet. If the “flag 1” has a value of “1”, it is found that the recognition has been completed The use of the “flag 1” is to cancel the unnecessary recognition operation after the completion of the recognition is found.

In the initial state, the recognition operation of the feedback clock signal CLKF has not been completed (i.e., the result of the step S111 is “NO”) and thus, the step S112 is carried out next. In the step S112, whether or not the dummy signals have been respectively outputted to the output terminals 13, 14, and 15 of the PLL element 11 is judged. The value of the lock signal LOCK is kept at “0” during this time, because none of the output clock signals CLK0, CLK1, and CLK2 have not been subjected to the phase adjustment with respect to the reference clock signal RCLK.

At this stage, none of the dummy signals have not been outputted. Therefore, the step S113 is then carried out, in which the three dummy signals having the logic values “0”, “1” and “X” are outputted to the output terminals 13, 14, and 15, respectively. Then, the value of the “flag 2” is set at “1”. The processing in the PLL model completed in this way.

The three dummy signals with the value of “0”, “1” and “X” are outputted using the rising change of the reference clock signal RCLK as a trigger. In FIG. 5, these dummy signals are outputted at the time t6 delayed from the time t1 by a short period.

Not to conduct the same processing after the dummy signals have been outputted once, the variable “flag 2” is used. If the “flag 2” has a value of “0”, it is found that the dummy signals have not been outputted yet. If the “flag 2” has a value of “1”, it is found that the output of the dummy signals has been completed.

The next step S114 is carried out at the time the feedback clock signal CLKF is changed by the application of one of the dummy signals outputted in the step S113 to the feedback terminal 17. In FIG. 5, the dummy signal fed back to the terminal 17 has a logic value of “1” and therefore, it is found that the output terminal 14 is connected to the terminal 17, in other words, it is found that the twofold output clock signal CLK1 is used as the feedback signal CLKF. In FIG. 5, this is judged at the time t2 delayed from the time t6 by a short period. After this judgment is completed, the value of the “flag 1” is set at “1” not to repeat the steps S112 to S114.

The subsequent steps S103 and S104 are conducted at the time t3 at which the reference clock signal RCLK rises again. Here, the phase difference between the signal RCLK and the signal CLKF, and the period of the signal RCLK are measured in the following way.

Specifically, according to the flowchart of phase comparison step S103 shown in FIG. 3, the reference clock signal RCLK is outputted within one period thereof and then, the times t4 and t5 at which the signal RCLK is fed back to the feedback terminal 17 are obtained. The difference between the times t4 and t3 (i.e., t4−t3) is the phase difference between the signals RCLK and CLKF. The difference between the times t5 and t3 (i.e., t5−t3) is the period T_{RCLK} of the signal RCLK.

Until this operation is completedr the lock signal LOCK is kept at the value “0” and thus, the signal LOCK is kept in the UNLOCK state. As a result, the subsequent circuit 20 is kept in the inoperable state.

After all the items to be measured are measured in the steps S103 and S104, the next step S105 of adding the delay value begins at the next rising event of the reference clock signal RCLK. As described previously, the PLL circuit 10 of FIG. 4 has the “phase adjustment period” that corresponds to six-time repetition of the rising event of the signal RCLK. To cope with this, the number of occurrence of the subsequent rising events of the signal RCLK is counted and then, the resulting data of counting is stored as the value of an internal variable.

In FIG. 5, the sixth rising event of the signal RCLK occurs at the time t8. Therefore, to match the phase of the feedback clock signal CLKF with the phase of the signal RCLK at the time t8, the step of adding the delay value (which is equal to the phase difference obtained in the step S103) to the signal CRKF needs to be carried out. To realize this, the schedule is made in such a way as to conduct the step of adding the delay value at the time the fifth rising event of the signal RCLK occurs.

In the step S106, the result obtained in the step S105 is outputted. In FIG. 5, the signals CRKF and RCLK rise simultaneously at the time t8. This means that the phases of the signals CRKF and RCLK are matched with each other at the time t8.

At the time t8, the phase difference between the signals CRKF and RCLK is checked. If the phase difference between the signals CRKF and RCLK is zero, i.e., if the phases of the signals CRKF and RCLK are matched with each other, the value of the lock signal LOCK is set at “1”. If the phases of the signals CRKF and RCLK are not matched with each other, the value of the lock signal LOCK is kept at “0”. This setting is carried out in the following way.

The phase matching of the signals CRKF and RCLK occurs at the time both the signa1s CRKF and RCLK have the logic value of “1”. Moreover, the periods or frequencies of the signals CRKF and RCLK are not always equal to each other. Thus, which one of the signals CRKF and RCLK is greater in period is checked and then, the phase comparison operation is carried out using the rising edge of the signal CRKF or RCLK having the greater period as a trigger in the following way.

Specifically, first, in the step S121 of FIG. 3, the time of the event (i.e., value change) of the signal RCLK is stored in the variable A. In the next step S122, the time of the event of the signal CLKF is stored in the variable B. In the next step S123, the times of the variables A and B thus stored are compared.

If it is judged that the phase of the reference clock signal RCLK is greater than the phase of the feedback clock signal CLKF in the step S123, the step S124 is then carried out, in which the rising event of the signal RCLK is checked. If the rising event of the signal RCLK is detected in the step S124, the step S126 is then carried out. If the rising event of the signal RCLK is not detected in the step S124, the step S102 of FIG. 1 is completed without conducting the subsequent steps.

If it is judged that the phase of the reference clock signal RCLK is not greater than the phase of the feedback clock signal CLKF in the step S123, the step S125 is then carried out, in which the rising event of the feedback clock signal CLKF is checked. If the rising event of the signal CLKF is detected in the step S125, the step S126 is then carried out. If the rising event of the signal CLKF is not detected in the step S125, the step S102 is completed without conducting the subsequent steps.

At the time t8, the phase of the reference clock signal RCLK is greater than the phase of the feedback clock signal CLKF. Thus, the step S124 is then carried out to check the rising event of the signal RCLK.

In the next step S126, it is judged whether or not the time of the event of the signal RCLK stored in the variable A is equal to the time of the event of the signal CLKF stored in the variable B. In other words, whether or not the signal RCLK rises at the same time as the signal CLKF is judged. If the signal RCLK rises at the same time as the signal CLKF, the step S127 is then carried out, in which the value of the lock signal LOCK is set at “1”. If the signal RCLK does not rise at the same time as the signal CLKF, the step S128 is then carried out, in which the value of the lock signal LOCK is set at “0”.

At the time t8, the signal RCLK rises at the same time as the signal CLKF and therefore, the value of the lock signal LOCK is set at “1”.

At the next time t9, the reference clock signal RCLK falls and the feedback clock signal CLKF rises. The value of the lock signal LOCK is never set at “0” at this time. This is because the step S103 is completed immediately after the step S124 is conducted without conducting the subsequent steps S126, S127, and S128.

With the method of simulating a PLL circuit according to the first embodiment of the invention, as described above, the three dummy signals having the different values “0”, “1”, and “X” are respectively outputted to the output clock terminals 13, 14, and 15 of the PLL circuit 10. Thereafter, the feedback clock signal CLKF fed back to the feedback input terminal 17 of the circuit 10 is checked to find which one of the dummy signals the signal CLKF thus fed back corresponds to, thereby recognizing which one of the output clock terminals 13, 14, and 15 is connected to the feedback input terminal 17.

Accordingly, even if the frequency of the output clock signal is changed (i.e., multiplied or divided) according to the necessity, the frequency of the feedback clock signal CLKF can be judged accurately to conduct the simulation of the PLL circuit 10. Moreover, no change is required for the simulation model used.

Moreover, which one of the output clock terminals 13, 14, and 15 is connected to the feedback input terminal 17 is recognized and thereafter, the PLL circuit 10 starts its operation. Thus, the operation of the circuit 10 is controlled accurately. As a result, the logic state of the lock signal LOCK outputted from the lock terminal 16 can be controlled accurately.

Furthermore, by adjusting the clock count of the reference clock signal RCLK required until the PLL circuit 10 starts its synchronization operation, the clock count necessary to reach the synchronization of the output clock signal CLK0, CLK1, or CLK2 with the reference clock signal RCLK can be adjusted.

### Comparison With the Method of 2000-278118

If the above-described simulation method of the first embodiment of the invention is applied to the prior-art logic simulation method disclosed in the previously-explained Publication No. 2000-278118, the following result is obtainable.

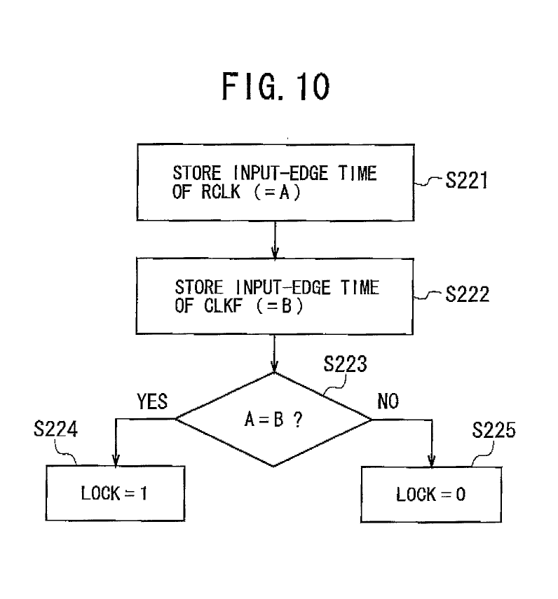

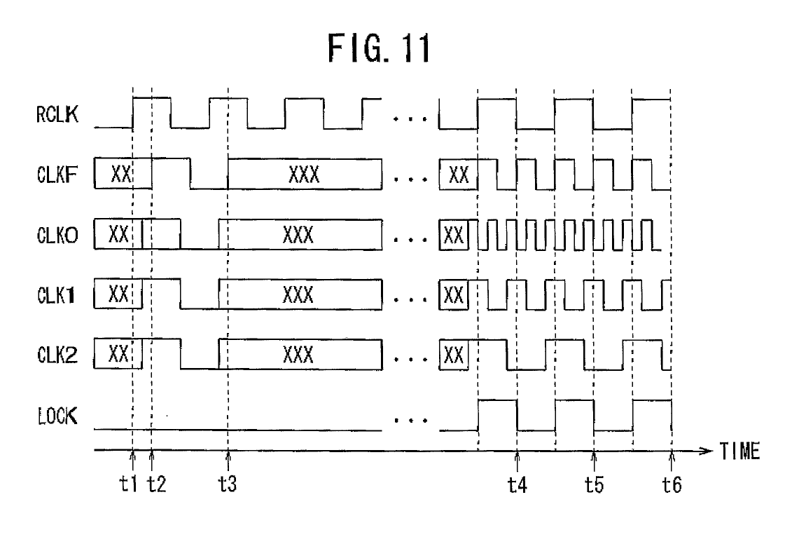

FIGS. 10 and 11 show a flowchart and a timing diagram showing the operation of this method.

As shown in FIG. 10, in the step S221, the time at which the input edge (i.e., the rising edge) of the reference clock signal RCLK occurs is recognized. This time is stored in the variable A.

In the next step S222, the time at which the input edge (i.e., the rising edge) of the feedback clock signal CLKF occurs is recognized. This time is stored in the variable B.

In the next step S223, it is judged whether or not the stored values or times of the variables A and B are equal to each other, in other words, it is judged whether or not the feedback clock signal CLKF changes at the same time as the reference clock signal RCLK. If the stored values or times of the variables A and B are equal, the step S224 is then carried out, in which the logic value of the lock signal LOCK is set at “1” (i.e., LOCK=1). If the stored values or times of the variables A and B are not equal, the stop S225 is then carried out, in which the logic value of the lock signal LOCK is kept or set at “0” (i.e., LOCK=0).

In this case, as shown in FIG. 11, the logic value of the lock signal LOCK is turned to “0” at the rising edges of the feedback clock signal CLKF at the times t4, t5, and t6. This means that it is judged that the phases of the signals RCLK and CLKF are not matched at these times. Thus, there arises a problem that the subsequent circuit 20 is kept inoperable even after the phases of the signals RCLK and CLKF are matched.

Accordingly, with the simulation method formed by combining the above-described simulation method of the first embodiment with the prior-art logic simulation method of the Publication No. 2000-278118, the objects of the invention are unable to be accomplished.

### Second Embodiment

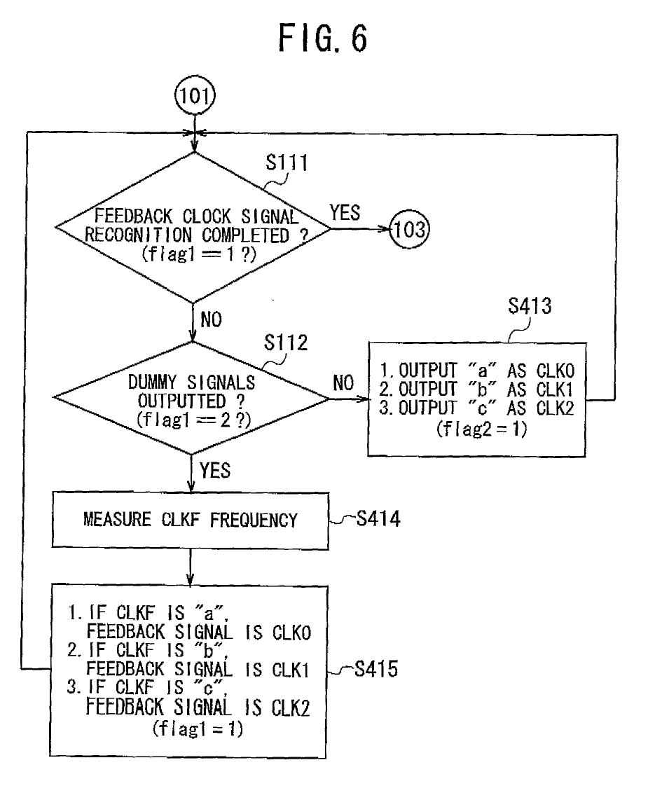

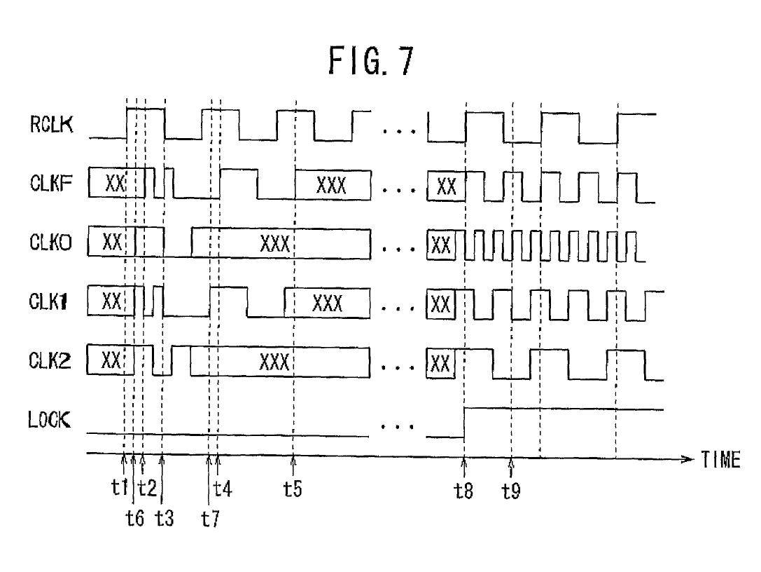

A method of simulating a PLL circuit according to.a second embodiment of the invention is explained below with reference to FIGS. 6 and 7. FIG. 6 shows the flowchart of this simulation method while FIG. 7 shows the timing diagram thereof.

With the simulation method of the first embodiment, the dummy signals having the logic 0, 1, and X are used to recognize the feedback clock signal CLKF. With the simulation method of the second embodiment, unlike this, dummy signals having pulses a, b, and c with different periods or repetition frequencies are used for the same purpose. Since itissufficientto recognize the signal CLKF, the frequencies of the pulses a, b, and c may be set optionally.

In the step S413 of FIG. 6, the dummy pulsed signals a, b, and c having the different periods or frequencies are outputted to the output terminals 13, 14, and 15, respectively. In other words, the output clock signals CLK0, CLK1, and CLK2 are replaced with the dummy pulsed signals a, b, and c, respectively. Then, the value of the “flag 2” is set at “1”. Thereafter, the flow is returned to the step S311.

In the step S414, the frequency of the feedback clock signal CLKF (i.e, the dummy signal) is measured. In the next step S415, the signal CLKF is recognized in the following way. Specifically, the frequency of the dummy signal thus fed back to the terminal 17 is checked and then, the dummy signal is judged as one of the pulsed signals a, b, and c according to the frequency thus checked. Subsequent1y, the flow is returned to the step S111.

Since the other operations in FIG. 6 are the same as those of FIG. 2, the explanation about them is omitted here.

In FIG. 7, the signals a, b, and care respectively outputted to the terminals 13, 14, and 15 from the time t1, thereby changing the signals CLK0, CLK1, and CLK2 at the time t6. Since the dummy signal fed back to the terminal 17 is recognized as the signals b, it is found that the terminal 15 is connected to the terminal 17. The other operation is the same as the first embodiment.

With the method of simulating a PLL circuit according to the second embodiment, as described above, the same advantages as those of the first embodiment are obtainable. There is an additional advantage that no limitation exists in the count of the output clock terminals of the PLL circuit 10 to which the simulation method of the second embodiment is applied.

### Third Embodiment

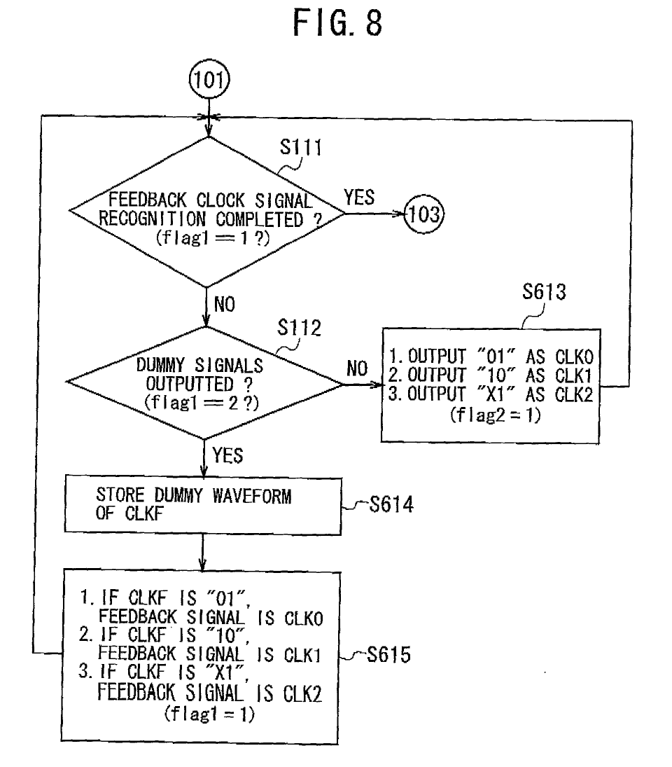

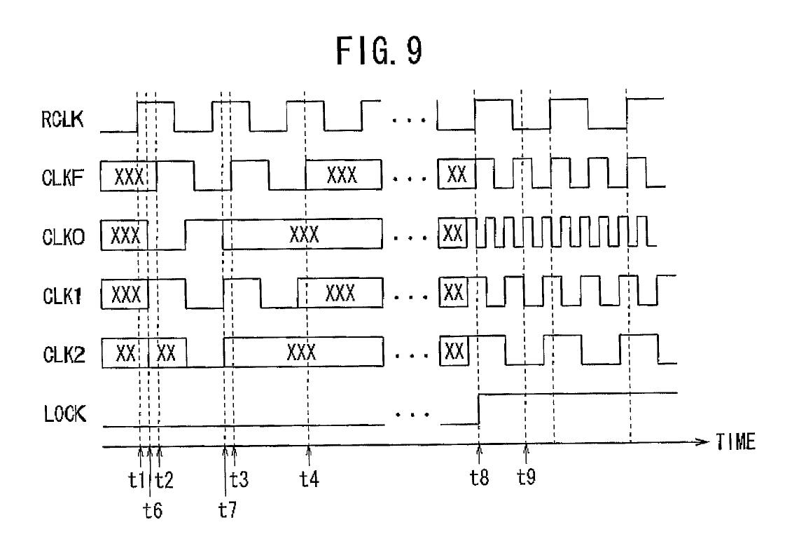

A method of simulating a PLL circuit according to a third embodiment of the invention is explained below with reference to FIGS. 8 and 9. FIG. 8 shows the flowchart of this simulation method while FIG. 9 shows the timing diagram thereof.

With the simulation method of the third embodiment, dummy signals having different combinations of the logic values “0”, “1”, and “X” are used. Since it is sufficient to recognize the signal CLKF, the combinations of the values “0”, “1”, and “X” may be formed optionally.

In the step S613 of FIG. 9, the dummy pulsed signals having the different combined pulses of “01”, “10”, and “X1” (2 bits) are outputted to the output clock terminals 13, 14, and 15, respectively. In other words, the output clock signals CLK0, CLK1, and CLK2 are replaced with the dummy signals having the different combinations “01”, “10”, and “X1”, respectively. Then, the value of the “flag 2” is set at “1”. Thereafter, the flow is returned to the step S111.

In the step S614 the waveform of the feedback clock signal CLKF (i.e, the dummy signal) is stored. In the next step S615, the signal CLKF is recognized in the following way. Specifically, the waveform of the dummy signal thus fed back to the terminal 17 is checked and then, the dummy signal is judged as one of the output clock signals CLK0, CLK1, and CLK2 according to the waveform thus checked. Subsequently, the flow is returned to the step S111.

Since the other operations in the flowchart of FIG. 8 are the same as those of FIG. 2, the explanation about them is omitted here.

In the timing diagram of FIG. 9, the dummy signals having the different combination of the two pulses selected from “01”, “10”, and “X1” are outputted to the terminals 13, 14, and 15, respectively. As a result, the output clock signals CLK0, CLK1, and CLK2 change at the time t6 and then, one of the signals CLK0, CLK1, and CLK2 is fed back to the terminal 17 at the time t2.

Since the twofold output clock signal CLK1 is fed back to the terminal 17 in FIG. 9, the dummy signal thus fed back to the terminal 17 is recognized as the combination of “10”. Thus, it is found that the output clock terminal 15 is connected to the feedback input terminal 17.

The other operations are the same as those of the first embodiment and thus, the explanation on them is omitted here.

With the method of simulating a PLL circuit according to the third embodiment, as described above, the same advantages as those of the first embodiment are obtainable. There is an additional advantage that no limitation exists in the count of the output clock terminals of the PLL circuit 10 to which the simulation method of the third embodiment is applied, if the bit number of each dummy signal is increased up to 3 bits or greater according to the count of the output clock terminals.

### Variations

Needless to say, the present invention is not limited to the above-described embodiments. Any change or modification may be added to the method of simulating a PLL circuit within the spirit of the invention.

For example, in the above-described embodiments, the fourfold, twofold, and unity-fold multiplication clock signals CLK0, CLK1, and CLK2 are respectively outputted from the output clock terminals 13, 14, and 15. Instead of this, division clock signals having different division factors may be respectively outputted from the output clock terminals. Both of division clock signals and multiplication clock signals may be respectively outputted from the output clock terminals. In these cases, the same advantages as the above-described first to third embodiments are obtainable.

Moreover, any signal may be used as each dummy signal if it can be discriminated with a proper method or contrivance.

While the preferred forms of the present invention have been described, it is to be understood that nodifications will be apparent to those skilled in the art without departing from the spirit of the invention. The scope of the present invention, therefore, is to be determined solely by the following claims.

What is claimed is:

1. A method of simulating a PLL circuit:
the PLL circuit having a reference input terminal into which a reference clock signal with a reference clock frequency is inputted, a feedback input terminal into which a feedback clock signal is inputted, and output terminals from which output clock signals are outputted;
the output clock signals including at least one of a multiplied output clock signal and a divided output clock signal;
the multiplied output clock signal having a frequency that corresponds to multiplication result of the reference clock frequency with a positive constant m greater than unity; and
the divided output clock signal having a frequency that corresponds to division result of the reference clock frequency by a positive constant n greater than unity;
the method comprising the steps of:
(a) outputting different dummy signals to the output terminals, respectively; and
(b) detecting a signal fed back to the feedback input terminal to find which one of the dummy signals the signal thus fed back corresponds to, thereby recognizing which one of the output terminals is connected to the feedback input terminal.

2. The method according to claim 1, wherein each of the dummy signals is a pulsed signal having a different logic value;

3. The method according to claim 2, wherein the pulsed signal includes at least two of “0”, “1”, and “X”.

4. The method according to claim 1, wherein each of the dummy signals is a pulsed signal having a different period or frequency.

5. The method according to claim 4, wherein the pulsed signal has a different repetition rate of pulses.

6. The method according to claim 1, wherein each of the dummy signals is a pulsed signal having a different combination of logic values.

7. The method according to claim 6, wherein the pulsed signal has a different combination of logic values of bits.

8. The method according to claim 1, after the step (b), further comprising the steps of;
(c) storing a first tine at which the reference clock signal occurs and a second time at which the feedback clock signal occurs;
(d) comparing a period of the reference clock signal with a period of the feedback clock signal:
(e) detecting occurrence of an event with respect to one of the reference clock signal and the feedback clock signal according to result of comparison in the step (d);
(f) judging whether or not the first time and the second time stored in the step (C) are equal to each other; and
(g) controlling a logic value of a specific lock signal according to result of judgment in the step (f), thereby making a specific subsequent circuit to the PLL circuit operable or inoperable.

9. A computer program product for simulating a PLL circuit;
the PLL circuit having a reference input terminal into which a reference clock signal with a reference clock frequency is inputted, a feedback input terminal into which a feedback clock signal is inputted, and output terminals from which output clock signals are outputted;
the output clock signals including at least one of a multiplied output clock signal and a divided output clock signal;
the multiplied output clock signal having a frequency that corresponds to multiplication result of the reference clock frequency with a positive constant m greater than unity; and
the divided output clock signal having a frequency that corresponds to division result of the reference clock frequency by a positive constant n greater than unity;
the program product having a computer readable medium and a computer program recorded thereon, which comprises:
(a) code that output respectively different dummy signals to the output terminals; and
(b) code that detects a signal fed back to the feedback input terminal to find which one of the dummy signals the signal thus fed back corresponds to, thereby discriminating which one of the output terminals is connected to the feedback input terminal.

10. The product according to claim 1, wherein each of the dummy signals is a pulsed signal having a different logic value;

11. The product according to claim 10, wherein the pulsed signal includes at least two of “0”, “1”, and “X”.

12. The product according to claim 9, wherein each of the dummy signals is a pulsed signal having a different period or frequency.

13. The product according to claim 12, wherein the pulsed signal has a different repetition rate of pulses.

14. The product according to claim 9, wherein each of the dummy signals is a pulsed signal having a different combination of logic values.

15. The product according to claim 14, wherein the pulsed signal has a different combination of logic values of bits.

16. The product according to claim 9, further comprising:
(c) code that stores a first time at which the reference clock signal occurs and a second time at which the feedback clock signal occurs;
(d) code that compares a period of the reference clock signal with a period of the feedback clock signal:
(e) code that detects occurrence of an event with respect to one of the reference clock signal and the feedback clock signal according to result of comparison in the step (d);
(f) code that judges whether or not the first time and the second time stored in the step (c) are equal to each other; and
(g) code that controls a logic value of a specific lock signal according to result of judgment in the step (f), thereby making a specific subsequent circuit to, the PLL circuit operable or inoperable;
wherein the codes (c) to (g) are carried out after the code (b).
